(19) United States
(12) Patent Application Publication
(10) Pub. No.: US 2025/0379612 A1
(43) Pub. Date: Dec. 11, 2025

(54) POWER LINE COMMUNICATION DEVICE AND METHOD THEREOF

(71) Applicant: TRENDYLITE CORPORATION, Miaoli County (TW)

(72) Inventor: Po-Wen KO, Miaoli County (TW)

(21) Appl. No.: 19/079,933

(22) Filed: Mar. 14, 2025

(30) Foreign Application Priority Data
Jun. 10, 2024 (TW) 113121395

(51) Int. Cl. H04B 3/54

(52) U.S. Cl. CPC H04B 3/542; H04B 2203/542

(57) ABSTRACT

The invention relates to a device adapted to transmit baseband signals with a power line of an AC power source. The invention uses both of the power line and a signal line for data transmission, rather than directly loading the signals onto the power line. Specifically, the device includes a rectification and energy storage circuit for continuously converting the AC power source into a current source with a common reference potential, ensuring uninterrupted communication for continuous data transmission. Moreover, the invention addresses the problem of noise interference by using the signal line for data transmission.

### PRIORITY CLAIM

This application claims priority to R.O.C. patent application No. 113121395 filed Jun. 10, 2024, the entirety of which is incorporated herein by reference.

### BACKGROUND OF THE INVENTION

### 1. Field of the Invention

The present invention relates to a communication device and a communication method adapted to transmit baseband signals with a power line of an alternating current (AC) power source and achieve a desired effect of continuous data transmission.

### 2. Description of the Related Art

Power line communication, often abbreviated as PLC and referred to as BPL (Broadband over Power Lines) in the modern communications industry, is a communication process that uses power lines to transmit data, video, and audio signals. Power lines are the most commonly found wiring in every room of a household, as most devices require power supplied through them. Therefore, power line networks are the most widely available and extensively covered resource. The power line communication technology involves converting data into a tandem for combining with high-frequency signals to synthesize a carrier signal. The carrier signal is then coupled to the power line for data transmission. Through a dedicated power line modulation/demodulation modem, the high-frequency signals are separated from the power line and transmitted to a terminal device for modulation/demodulation to get the signals from the power line for subsequent use.

Although utilizing power lines as the backbone transmission medium for home (or local) networks eliminates the need for additional wiring and, thus, has the advantages of saving installation costs and time, power lines are originally intended for transmitting electricity and are not inherently ideal for communication. When mains electricity and power line communication (PLC) carrier signals are transmitted simultaneously, the PLC carrier signals are susceptible to interference from noise generated by other electrical equipment. This interference can result in partial data packet transmission failures, reduced transmission speeds, and, in severe cases, paralysis of the PLC network.

To address this issue, a communication technique has been proposed in US2018/0287665A1, entitled “Power Line-Based Communication Method and Device,” which involves providing a threshold voltage as a comparison reference for an AC input voltage to determine whether the communication is permitted. If the AC input voltage is greater than the threshold voltage, the communication is permitted. On the contrary, if the AC input voltage is lower than the threshold voltage, the communication is prohibited. This approach ensures that the initiation time and the termination time of the baseband signal communication for each load are synchronized, thereby enhancing reliability. It further employs a separate signal line for data transmission instead of directly loading signals onto the power line, effectively mitigating the issue of noise interference.

However, the technique disclosed in the patent publication above requires a voltage comparison module to perform voltage comparison as a means to determine the permitted communication period (duty time) and the prohibited communication period (forbidden time). The existence of a forbidden time results in periods where communication is not possible. Additionally, the need for a voltage comparison module increases the overall circuit complexity and leads to higher production costs.

### SUMMARY OF THE INVENTION

Disclosed herein are a communication device and a communication method adapted to transmit baseband signals with a power line of an AC power source and achieve a desired effect of continuous data transmission. To achieve this objective, the power line communication device comprises an AC power input terminal having a first power line, a second power line and a signal line; a rectification and energy storage circuit connected to the first power line and the second power line and having a full-wave rectification unit, two energy storage units, a first output terminal and a second output terminal; and a signal transmission interface electrically connected to the first output terminal and the second output terminal of the rectification and energy storage circuit and the signal line, wherein the signal transmission interface receives a current source with a common reference potential from the first and second output terminals as the AC power source is input.

Compared to the traditional powerline communication (PLC) techniques, the device and method herein utilizes a signal line within the power line for data transmission, in contrast to the conventional way of directly loading signals onto the power line. This modification not only improves the noise interference problem that often occurs in power line communication, but also eliminates the need for an isolation system and a modulation/demodulation system. Moreover, by employing a rectification and energy storage circuit, the AC power source is continuously converted into a current source with a common reference potential, thus enabling uninterrupted data transmission and achieving the effect of continuous communication.

In preferred embodiments, the rectification and energy storage circuit further comprises two unidirectional conduction units electrically connected between the full-wave rectification unit and the first output terminal, respectively.

In a preferred embodiment, the two unidirectional conduction units are in form of diodes D5, D6, respectively, each having an anode and a cathode, wherein the anode of the diode D5 is electrically connected to the cathode of the diode D1 and one terminal of the capacitor C1, while the anode of the diode D6 is electrically connected to the cathode of the diode D2 and one terminal of the capacitor C2, and the cathodes of diodes D5 and D6 are connected in parallel to the first output terminal.

In a preferred embodiment, the full-wave rectification unit comprises a positive half-cycle current path and a negative half-cycle current path, and the two energy storage units are electrically connected to the positive half-cycle current path and the negative half-cycle current path of the full-wave rectification unit, respectively.

In a preferred embodiment, the full-wave rectification unit comprises four diodes D1 to D4, and the two energy storage units are in form of capacitors C1, C2, respectively, and wherein the capacitor C1 is electrically connected to the positive half-cycle current path formed by the diodes D1, D3, while the capacitor C2 is electrically connected to the negative half-cycle current path formed by the diodes D2, D4.

In a more preferred embodiment, the signal transmission interface is adapted to continuously perform baseband signal communication through the signal line, where the baseband signal communication comprises TX transmission signals and RX reception signals.

### BRIEF DESCRIPTION OF THE DRAWINGS

FIG. 1 is a structural schematic diagram of a communication device according to the invention;

FIG. 2 is a structural schematic diagram of a communication device according to the first embodiment of the invention;

FIG. 3 is a structural schematic diagram of a rectification and energy storage circuit according to the second embodiment of the invention;

FIG. 4 is a structural schematic diagram of a communication device according to the second embodiment of the invention;

FIG. 5 is the signal waveform diagram when the communication device according to the invention is in use; and

FIG. 6 is the signal waveform diagram when a conventional communication device is in use.

### DETAILED DESCRIPTION OF THE INVENTION

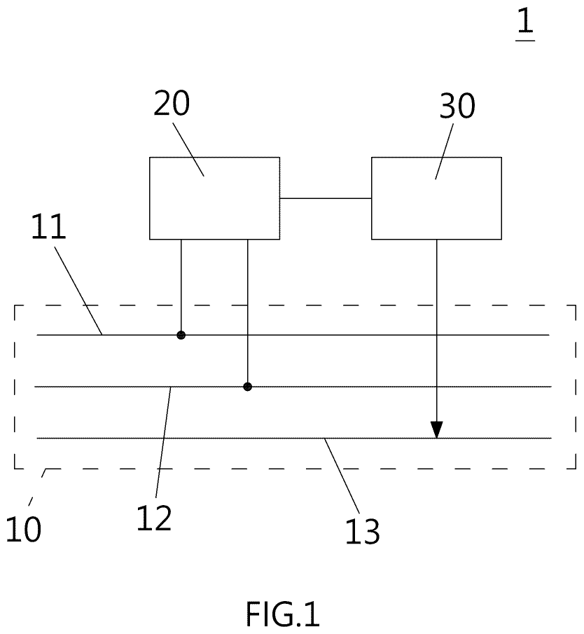

Referring to FIG. 1, which is a schematic structural diagram of the power line communication device according to the invention, The device 1 disclosed herein comprises an AC power input terminal 10, a rectification and energy storage circuit 20, and a signal transmission interface 30.

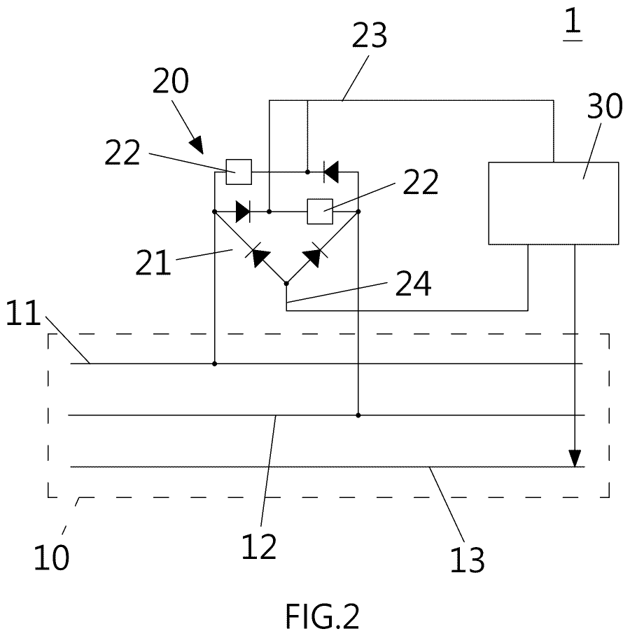

The AC power input terminal 10 comprises a first power line 11, a second power line 12, and a signal line 13. The rectification and energy storage circuit 20 is connected to the AC power input terminal 10. According to the first embodiment shown in FIG. 2, the rectification and energy storage circuit 20 is connected to the first power line 11 and the second power line 12 and comprises a full-wave rectification unit 21, two energy storage units 22, a first output terminal 23, and a second output terminal 24. The two energy storage units 22 are electrically connected to the positive half-cycle current path and the negative half-cycle current path of the full-wave rectification unit 21, respectively.

The signal transmission interface 30 is electrically connected to the first output terminal 23 and the second output terminal 24 of the rectification and energy storage circuit, as well as to the signal line 13.

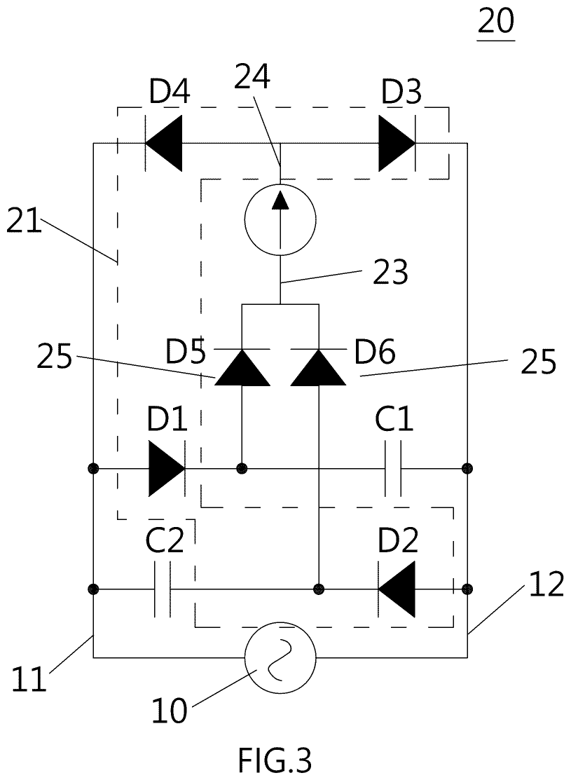

According to the second embodiment shown in FIG. 3, the full-wave rectification unit 21 includes four diodes, D1 to D4. The two energy storage units are configured in form of capacitors C1, C2, where capacitor C1 is electrically connected to the positive half-cycle current path formed by diodes D1, D3, while capacitor C2 is electrically connected to the negative half-cycle current path formed by diodes D2, D4. By virtue of the four diodes D1 to D4, the input AC power source is fully rectified. The capacitors C1, C2 are adapted to store energy through the positive and negative half-cycle current paths, respectively, allowing for continuous output of a current source A with a common reference potential under AC power input.

Furthermore, the rectification and energy storage circuit 20 further comprises two unidirectional conduction units 25 electrically connected between the full-wave rectification unit 21 and the first output terminal 23. According to the embodiment shown in the drawing, the two unidirectional conduction units 25 are in form of diodes D5, D6. Each diode D5, D6 has an anode and a cathode. The anode of diode D5 is electrically connected to the cathode of diode D1 and one terminal of capacitor C1, while the anode of diode D6 is electrically connected to the cathode of diode D2 and one terminal of capacitor C2. The cathodes of diodes D5, D6 are connected in parallel to the first output terminal 23. The unidirectional conductivity of diodes D5, D6 ensures that the current source is reliably output to the signal transmission interface 30.

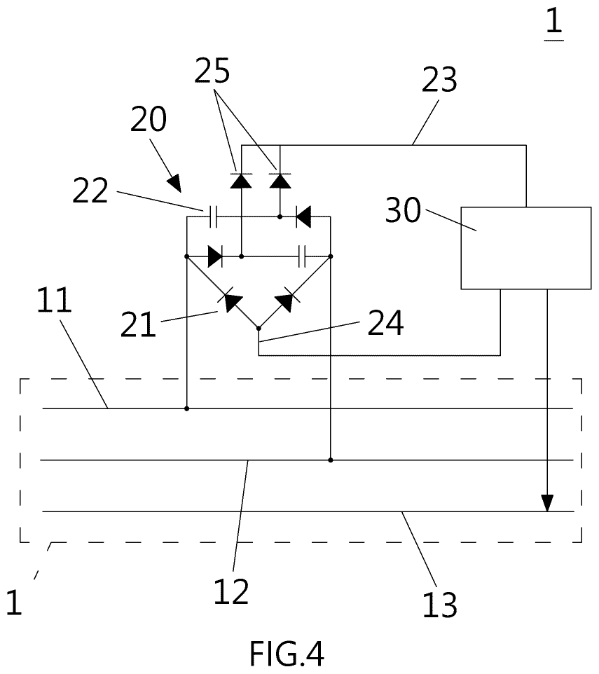

According to the third embodiment shown in FIG. 4, the rectification and energy storage circuit 20 is connected to the first power line 11 and the second power line 12, both of which are adapted for transmitting the AC power source. The signal level reference ground is in compliance with the input AC power source to correspond to the first and second power lines 11, 12 through the rectification and energy storage circuit 20. That is to say, when the input AC power source is in the positive half-cycle, the signal level reference ground is located at the second power line 12, and the positive half-cycle current path of the full-wave rectification unit is in a conducting state, while the negative half-cycle current path is in a cutoff state. Conversely, when the input AC power source is in the negative half-cycle, the signal level reference ground is located at the first power line 11, with the positive half-cycle current path in a cutoff state and the negative half-cycle current path in a conducting state.

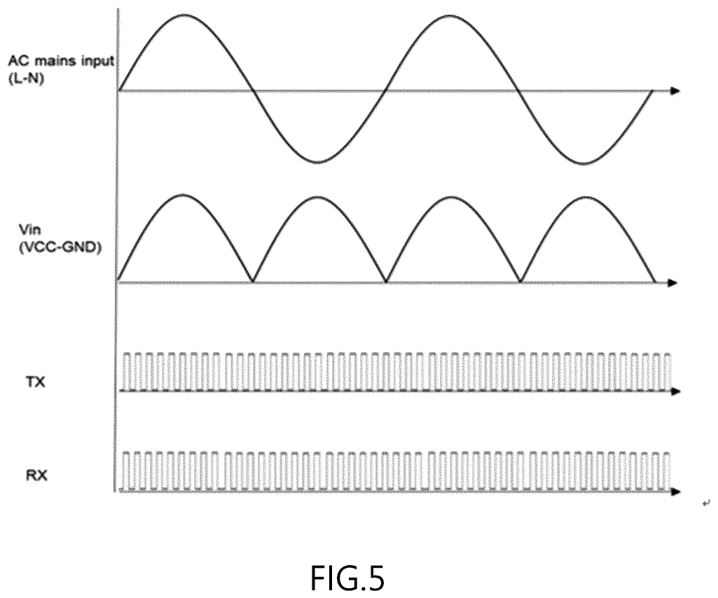

Further referring to the AC signal waveform diagram shown in FIG. 5, after the AC power source is input through the AC power input terminal 10, full-wave rectification is performed through the alternating conduction of the positive half-cycle current path formed by diodes D1, D3 and the negative half-cycle current path formed by diodes D2, D4 (as shown by the Vin waveform in FIG. 5). The signal level reference ground is thus alternately located at the first power line 11 and the second power line 12, while energy storage is alternately carried out by capacitors C1 and C2 connected to the positive and negative half-cycle current paths, respectively. A current source A with a common reference potential is then continuously transmitted from the first output terminal 23 and the second output terminal 24 to the signal transmission interface 30 (as shown by the TX and RX waveforms in FIG. 5). This allows the signal transmission interface 30 to maintain uninterrupted communication, enabling the continuous transmission of baseband signals via the signal line 13. The baseband signal transmission may include the TX transmission signal and the RX reception signal shown in FIG. 5.

The invention provides a communication device and a communication method for transmitting baseband signals with a power line of an AC power source, which is useful for a load adapted to receive mains electricity, including but being not limited to a light source (such as a light emitting diode lamp), a sensor and a display. While the electricity is transmitted, baseband signal communication can also proceed. A user is allowed to directly accomplish smart remote control simply by connecting each load to a conventional three-wire connector.

Taking light sources as an example, a control system can be electrically connected in series to a plurality of light sources through power lines, with the respective light sources being electrically connected to the power lines through the power line communication device herein. Users can preset various control modes via the control system, such as turning on or turning off the light sources and adjusting brightness of the light sources. The control system can convert any of the various control modes into baseband signals, and the power line is used for transmission of the baseband signals, which is not only capable of controlling on or off of the light source or evening dimming by using the power line, but also has the advantages of achieving wide coverage, easy connection and high transmission rate by using existing wires.

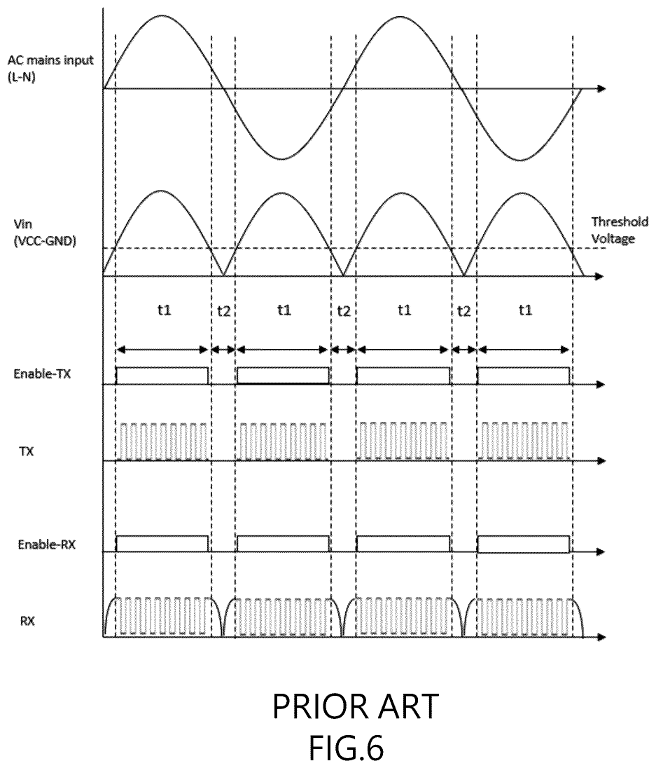

It is worthwhile to note that compared with the traditional powerline communication (PLC) technology, the invention utilizes a signal line incorporated in the power lines for data transmission rather than directly loading signals on the power lines, which not only improves the noise interference problem that often occurs during power line communication, but also spare the use of a voltage comparison module, an isolation system and a modulation/demodulation system, thus achieving a simpler circuitry and system architecture. Moreover, the invention employs a rectification and energy storage circuit to continuously convert the input AC power source into a current source with a common reference potential, ensuring uninterrupted communication and achieving continuous transmission. This approach overcomes the limitation of conventional power line communication, where a communication blackout period (forbidden period) occurs at the AC power zero-crossing points, preventing data transmission. As shown in FIG. 6, in conventional PLC devices, the TX transmission signal and RX reception signal are allowed to transmit during the operation period t1. However, at the AC power zero-crossing points, no current is generated, resulting in a forbidden period t2 where communication is not possible.

Unless specified otherwise, the following terms as used in the specification and appended claims are given the following definitions. It should be noted that the indefinite article “a” or “an” as used in the specification and claims is intended to mean one or more than one, such as “at least one,” “at least two,” or “at least three,” and does not merely refer to a singular one. In addition, the terms “comprising/comprises,” “including/includes” and “having/has” as used in the claims are open languages and do not exclude unrecited elements. The term “or” generally covers “and/or”, unless otherwise specified. The terms “about” and “substantially” used throughout the specification and appended claims are used to describe and account for small fluctuations or slight changes that do not materially affect the nature of the invention.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

I claim:

1. A power line communication device, comprising:
an AC power input terminal having a first power line, a second power line and a signal line;
a rectification and energy storage circuit connected to the first power line and the second power line and comprising a full-wave rectification unit, two energy storage units, a first output terminal and a second output terminal; and
a signal transmission interface electrically connected to the first output terminal and the second output terminal of the rectification and energy storage circuit and the signal line, wherein the signal transmission interface receives a current source with a common reference potential from the first and second output terminals as the AC power source is input.

2. The power line communication device according to claim 1, wherein the rectification and energy storage circuit further comprises two unidirectional conduction units electrically connected between the full-wave rectification unit and the first output terminal, respectively.

3. The power line communication device according to claim 2, wherein the two unidirectional conduction units are in form of diodes D5, D6, respectively.

4. The power line communication device according to claim 3, wherein the full-wave rectification unit comprises a positive half-cycle current path and a negative half-cycle current path, and the two energy storage units are electrically connected to the positive half-cycle current path and the negative half-cycle current path of the full-wave rectification unit, respectively.

5. The power line communication device according to claim 4, wherein the full-wave rectification unit comprises four diodes D1 to D4, and the two energy storage units are in form of capacitors C1, C2, respectively, and wherein the capacitor C1 is electrically connected to the positive half-cycle current path formed by the diodes D1, D3, while the capacitor C2 is electrically connected to the negative half-cycle current path formed by the diodes D2, D4.

6. The power line communication device according to claim 5, wherein each of the diodes D5, D6 has an anode and a cathode, and wherein the anode of the diode D5 is electrically connected to the cathode of the diode D1 and one terminal of the capacitor C1, while the anode of the diode D6 is electrically connected to the cathode of the diode D2 and one terminal of the capacitor C2, and the cathodes of diodes D5 and D6 are connected in parallel to the first output terminal.

7. The power line communication device according to claim 5, wherein the signal transmission interface is adapted to continuously perform baseband signal communication through the signal line, where the baseband signal communication comprises TX transmission signals and RX reception signals.

8. The power line communication device according to claim 1, wherein the full-wave rectification unit comprises a positive half-cycle current path and a negative half-cycle current path, and the two energy storage units are electrically connected to the positive half-cycle current path and the negative half-cycle current path of the full-wave rectification unit, respectively.

9. The power line communication device according to claim 8, wherein the full-wave rectification unit comprises four diodes D1 to D4, and the two energy storage units are in form of capacitors C1, C2, respectively, and wherein the capacitor C1 is electrically connected to the positive half-cycle current path formed by the diodes D1, D3, while the capacitor C2 is electrically connected to the negative half-cycle current path formed by the diodes D2, D4.

10. A power line communication method for transmitting baseband signals with a power line of an AC power source, comprising a rectification and energy storage step of converting the AC power source into a current source with a common reference potential.

11. The power line communication method according to claim 10, wherein the rectification and energy storage step comprises electrically connecting a rectification and energy storage circuit to the AC power source comprising a first power line and a second power line for connection to the rectification and energy storage circuit, respectively, and wherein the rectification and energy storage circuit comprises a full-wave rectification unit, two energy storage units, a first output terminal, and a second output terminal, and wherein the full-wave rectification unit comprises a positive half-cycle current path and a negative half-cycle current path, with the two energy storage units electrically connected to the respective positive and negative half-cycle current paths, respectively.

12. The power line communication method according to claim 11, wherein the full-wave rectification unit comprises four diodes D1 to D4, and the two energy storage units are ion form of capacitors C1, C2, respectively, and wherein the capacitor C1 is electrically connected to the positive half-cycle current path formed by the diodes D1, D3, while the capacitor C2 is electrically connected to the negative half-cycle current path formed by the diode D2, D4.

13. The power line communication method according to claim 11, further comprising electrically connecting a signal transmission interface to the first output terminal and the second output terminal of the rectification and energy storage circuit and the signal line, wherein the signal transmission interface is adapted for receiving a current source with a common reference potential from the first and second output terminals as the AC power source is input and continuously transmitting the baseband signals through the signal line.
